(19) United States
(12) Patent Application Publication
(10) Pub. No.: US 2001/0034751 A1
(43) Pub. Date: Oct. 25, 2001

(54) Real-time OS simulator

(76) Inventors: Shinichiro Eto, Hiroshima (JP); Masayoshi Kareki, Higashihiroshima (JP); Kouji Sasaki, Higashihiroshima (JP); Masahiro Oashi, Kyotanabe (JP)

Correspondence Address: WENDEROTH, LIND & PONACK, L.L.P., 2033 K STREET N. W., SUITE 800, WASHINGTON, DC, 20006-1021, US

(21) Appl. No.: 09/837,205

(22) Filed: Apr. 19, 2001

(30) Foreign Application Priority Data
Apr. 21, 2000 (JP) 2000-120903

(51) Int. Cl. G06F 9/00

(52) U.S. Cl. 709/100; 709/108

(57) ABSTRACT

A real-time OS simulator simulates dispatch processing and interrupt handling of a real-time OS on a general-purpose multi-thread OS. Threads 21 to 23 corresponding to tasks, threads 31 to 33 that generate an interrupt, and a thread 11 for controlling concurrent thread running on the multi-thread OS. Each of the threads 21 to 23, selects, when calling a system function, any thread to run next, instructs the thread 11 to start processing, and then suspends itself. After the running thread is suspended, the instructed thread 11 resumes the selected thread. Any one of the threads 31 to 33 that called an interrupt handling function 13 suspends the running thread, calls an interrupt handler, and then selects any thread to run next for resuming. In addition to the threads 21 to 23, an exception handling thread may be assigned for each task.

### BACKGROUND OF THE INVENTION

1. Field of the Invention

The present invention relates to real-time OS simulators used for developing application software incorporated in an embedded system.

2. Description of the Background Art

Embedded systems such as cellular phones and digital TVs incorporate application software unique to each of these systems. Such software for embedded systems is realized as multi-task software executed on a real-time operating system (OS) The multi-task software is conventionally developed by using a software development system composed of a breadboard, ICE (In Circuit Emulator), and other components. Such system, hereinafter referred to as a real system, has to be prepared before software development, and therefore software development time is forced to become short. Moreover, real systems may not be provided enough to all software developers as required. Furthermore, as the operating frequency of the real system rises, debugging by the ICE becomes difficult.

One solution to the above problems is constructing, on a general-purpose personal computer or work station, a system similar in operation to the real system and developing software for embedded systems by using the constructed system. In one method, a “real-time OS simulator” is used for relating a task in the real system to a thread in a general-purpose multi-thread OS (hereinafter referred to as general-purpose OS) and simulating the operation of a real-time OS. Such real-time OS simulator can be easily realized by simulating multi-task capabilities of the real-time OS with the use of multi-thread capabilities provided by the general-purpose OS. Also, only developing real-time OS simulator is enough for providing software development systems to software developers. Therefore, efficiency and reliability of software development can be increased. Hereinafter, the thread in this specification includes a “process” called in some general-purpose OSes.

The real-time OS carries out a variety of processes such as task synchronization management, timer management, task-to-task communications, and memory management. Among these, to realize dispatch processing for switching running tasks and interrupt handling for calling an interrupt handler, the real-time OS uses hardware for real systems. The real-time OS simulator, on the other hand, cannot use such hardware and thus cannot carry out the dispatch processing and interrupt handling.

The real-time OS carries out multi-level interrupt handling, in which an interrupt newly occurred in an interrupt handler may be handled first. Furthermore, the real-time OS carries out dispatch processing as required when called in a task or interrupt handler. When called in a task, the real-time OS immediately starts to carry out dispatch processing. When called in an interrupt handler, on the other hand, it starts to carry out dispatch processing after returning from the interrupt handler (such processing is hereinafter referred to as delayed dispatch processing). The above described processes including delayed dispatch processing and multi-level interrupt handling, and other capabilities of the real-time OS have to be simulated as closely as possible by the real-time OS simulator.

FIG. 24 is a diagram showing the software configuration of a control software execution system of a numerical control device disclosed in Japanese Patent Gazette No. 2820189. Note that FIG. 24 shows an abstract representation of the configuration without impairing the subject of the disclosed invention for easier comparison with the present invention. Four threads shown in FIG. 24 run concurrently on a host computer equipped with a general-purpose OS. Of these threads, three threads 91 to 93 carry out the same processes as those realized by tasks running in the numerical control device separately provided from the host computer. The remaining thread, that is, a scheduler thread 90, regularly interrupts the threads 91 to 93, dynamically switching among the threads to run. According to this software execution system, the control software of the numerical control device can operate on the host computer.

However, the scheduler thread 90 shown in FIG. 24 cannot serve as a real-time OS simulator for use in developing software for embedded systems. The reasons for this are described below.

Firstly, the scheduler thread 90 regularly interrupts the threads 91 to 93, carrying out preemptive control by dynamically switching among the threads to run. In the real system, on the other hand, non-preemptive task control is carried out, where the running task is switched when the task calls the real-time OS. The conventional method does not allow such non-preemptive task control, which is one of the characteristics of the real-time OS.

Secondly, the scheduler thread 90 carries out the above thread control under the assumption that the general-purpose OS equally controls all threads. However, a thread scheduling algorithm of the general-purpose OS is generally not publicized. Also, some general-purpose OSes separately calculate thread priorities based on given thread priorities, and controls thread running based on the calculated thread priorities. Such general-purpose OS cannot control thread running only by setting the thread priorities by application software. Therefore, if the conventional method is implemented with such general-purpose OS, only the threads 91 to 93 possibly run, and the scheduler 90 does not at all.

Lastly, the scheduler thread 90 is not able to carry out interrupt handling required for the real-time OS simulator. Software for embedded systems operates in response to an interrupt externally provided. In the conventional method, however, such interrupt cannot be handled.

### SUMMARY OF THE INVENTION

Therefore, an object of the present invention is to provide a real-time OS simulator that closely simulates dispatch processing and interrupt handling carried out by a real-time OS, even on a general-purpose multi-thread OS using an arbitrary thread scheduling algorithm.

The present invention has the following features to solve the problems above.

A first aspect of the present invention is directed to a real-time OS simulator that assigns a task processing thread to run on a general-purpose multi-thread OS to each of a plurality of tasks to run on a real-time OS and simulates an operation of the real-time OS on the multi-thread OS, the simulator comprising:

a task switching instruction part for receiving a request issued from the task processing thread under same conditions as in the real-time OS, and providing an instruction for switching the tasks in response to the request;

a task switching thread for making selected one of the task processing threads run by suspending and resuming the task processing threads with capabilities of the multi-thread OS in cooperation with the task switching instruction part.

As described above, in the first aspect, with the operations of the task switching instruction part and the task switching thread, only one task processing thread is selected for running. Thus, the dispatch processing in the real-time OS can be simulated irrespectively of the thread scheduling algorithm provided by the multi-thread OS.

According to a second aspect, in the first aspect, the task switching instruction part selects a task processing thread to run next, provides the instruction for switching the tasks to the task switching thread, and then suspends the task processing thread that has issued the request, and

in response to the instruction, the task switching thread resumes the selected task processing thread after a preceding running task processing thread is suspended.

As described above, in the second aspect, the task switching thread resumes the task processing thread to run next after the preceding running task processing thread is suspended. Thus, only one task processing thread can enter a runnable state.

In this case, in response to the instruction for switching the tasks, the task switching thread may check at predetermined intervals whether the preceding running task thread is suspended or not. Thus, irrespectively of the thread scheduling algorithm provided by the multi-thread OS, the task switching thread can run after the preceding running task processing thread is suspended.

According to a third aspect, in the first aspect, the task switching instruction part selects a task processing thread to run next, provides the instruction for switching the tasks to the task switching thread, and then sets the task processing thread that has issued the request in a waiting state, and

in response to the instruction, the task switching thread suspends a preceding running task processing thread, and then releases the selected task processing thread from the waiting state for resuming.

As described above, in the third aspect, after the task switching thread suspends the preceding running task processing thread, the task processing thread to run next is resumed. Thus, only one task processing thread can enter the runnable state.

In the second or third aspect, the task switching instruction part may provide the instruction to the task switching thread after the task switching thread is enabled to start processing. Thus, a plurality of task processing threads do not simultaneously instruct the task switching thread to start processing. Therefore, the task switching thread can surely carry out dispatch processing.

According to a fourth aspect, in the first aspect, the task switching instruction part provides the instruction to the task switching thread after selecting a task processing thread to run next, and

the task switching thread runs with a higher priority than the task processing threads and, in response to the instruction, suspends a preceding running task processing thread and then resumes the selected task processing thread.

As described above, in the fourth aspect, if the multi-thread OS on which threads run according to specified priorities is used, the task switching thread runs with a higher priority than the task processing threads. Thus, only one task processing thread can enter the runnable state without requiring a waiting state for each task processing thread.

According to a fifth aspect, in the first aspect, an exception handling thread corresponding to task exception handling of each of the tasks and running on the multi-thread OS is further assigned to each of the tasks, and

the task switching thread selects a thread to run next from among the task processing threads and the exception handling threads.

As stated above, in the fifth aspect, one task processing thread and one exception handling thread are assigned to each task. The operations of the task switching instruction part and the task switching thread can control running of these two types of thread, thereby simulating the task exception handling of the real-time OS.

According to a sixth aspect, in the first aspect, the real-time OS simulator further comprises an interrupt handling part for receiving an interrupt request issued by an interrupt thread that generates a pseudo-interrupt, suspending a running task processing thread, calling an interrupt handler corresponding to the interrupt request, and then selecting a task processing thread to run next for resuming.

As stated above, in the sixth aspect, by using the interrupt handling part, the interrupt thread suspends the running task processing thread, and calls the interrupt handler. Thus, irrespectively of the thread scheduling algorithm provided by the multi-thread OS, the interrupt handling and the delayed dispatch processing of the real-time OS can be simulated.

In this case, when receiving the interrupt request from the interrupt thread while another interrupt thread is running, the interrupt handling part may suspend the running interrupt thread, call the interrupt handler corresponding to the interrupt request, and then resume the suspended interrupt thread. Thus, by using the interrupt handling part, the interrupt thread suspends the running interrupt thread and call the interrupt handler corresponding to the subsequent interrupt, thereby simulating the multi-level interrupt handling of the real-time OS.

Also, the interrupt thread may include a system clock interrupt thread that generates a pseudo-interrupt at predetermined time intervals. Thus, the timer management capability of the real-time OS can be simulated.

According to a seventh aspect, in the first aspect, the real-time OS simulator further includes a task processing thread creating part for creating the task processing thread, a thread creating part for creating the task processing thread and the exception handling thread, and/or an interrupt thread creating part for creating the interrupt thread.

As stated above, in the seventh aspect, the simulator can create various threads by itself, simulating dispatch processing, task exception handling and interrupt handling.

An eighth aspect of the present invention is directed to a computer-readable recording medium recording a program to run on a computer, the program for a simulation method of assigning a task processing thread to run on a general-purpose multi-thread OS to each of a plurality of tasks to run on a real-time OS and simulating an operation of the real-time OS on the multi-thread OS, the simulation method comprising the steps of:

receiving a request issued from the task processing thread under same conditions as the real-time OS and providing an instruction for switching the tasks in response to the request; and

making selected one of the task processing threads run by suspending and resuming the task processing threads with capabilities of the multi-thread OS.

A ninth aspect of the present invention is directed to a program for a simulation method of assigning a task processing thread to run on a general-purpose multi-thread OS to each of a plurality of task to run on a real-time OS and simulating an operation of the real-time OS on the multi-thread OS, the simulation method comprising the steps of:

receiving a request issued from the task processing thread under same conditions as the real-time OS and providing an instruction for switching the tasks in response to the request; and

making selected one of the task processing threads run by suspending and resuming the task processing threads with capabilities of the multi-thread OS.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the hardware construction of a computer system in which a real-time OS simulator according to a first embodiment of the present invention operates;

FIG. 2 is a diagram showing the software configuration of the real-time OS simulator according to the first embodiment of the present invention;

FIG. 3 is a flowchart showing main processing of the real-time OS simulator according to the first embodiment of the present invention;

FIG. 4 is a flowchart showing the operation of a changer thread in the real-time OS simulator according to the first embodiment of the present invention;

FIG. 5 is a flowchart showing the operation of a system function in the real-time OS simulator according to the first embodiment of the present invention;

FIG. 6 is one exemplary timing chart showing dispatch processing carried out by the real-time OS simulator according to the first embodiment of the present invention;

FIG. 7 is another exemplary timing chart showing the dispatch processing carried out by the real-time OS simulator according to the first embodiment of the present invention;

FIG. 8 is still another exemplary timing chart showing the dispatch processing carried out by the real-time OS simulator according to the first embodiment of the present invention;

FIG. 9 is a flowchart showing the operation of an interrupt handling function of the real-time OS simulator according to the first embodiment of the present invention;

FIG. 10 is one exemplary timing chart showing interrupt handling of the real-time OS simulator according to the first embodiment of the present invention;

FIG. 11 is another exemplary timing chart showing the interrupt handling of the real-time OS simulator according to the first embodiment of the present invention;

FIGS. 12A and 12B are another exemplary timing chart showing the interrupt handling of the real-time OS simulator according to the first embodiment of the present invention;

FIG. 13 is still another exemplary timing chart showing the interrupt handling of the real-time OS simulator according to the first embodiment of the present invention;

FIG. 14 is a flowchart showing the operation of a changer thread in a real-time OS simulator according to a second embodiment of the present invention;

FIG. 15 is a flowchart showing the operation of a system function in the real-time OS simulator according to the second embodiment of the present invention;

FIG. 16 is one exemplary timing chart showing dispatch processing by the real-time OS simulator according to the second embodiment of the present invention;

FIG. 17 is another exemplary timing chart showing the dispatch processing by the real-time OS simulator according to the second embodiment of the present invention;

FIG. 18 is an exemplary timing chart showing how tasks are switched by a real-time OS that supports task exception processing;

FIG. 19 is a diagram showing the software configuration of a real-time OS simulator according to a third embodiment of the present invention;

FIG. 20 is a diagram showing main processing of the real-time OS simulator according to the third embodiment of the present invention;

FIG. 21 is a flowchart showing the operation of a changer thread in the real-time OS simulator according to the third embodiment of the present invention;

FIG. 22 is flowchart showing an exception processing thread in the real-time OS simulator according to the third embodiment of the present invention;

FIG. 23 is an exemplary timing chart of task exception processing by the real-time OS simulator according to the third embodiment of the present invention; and

FIG. 24 is a diagram showing the software configuration of a conventional control software execution system.

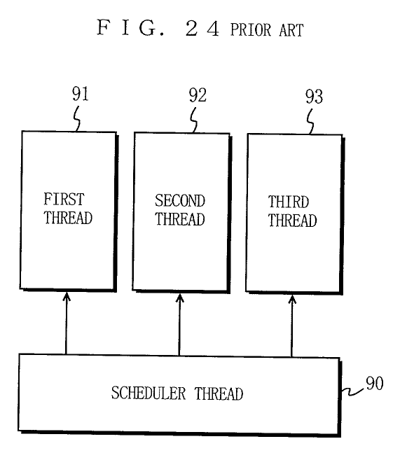

### DESCRIPTION OF THE PREFERRED EMBODIMENTS

### First Embodiment

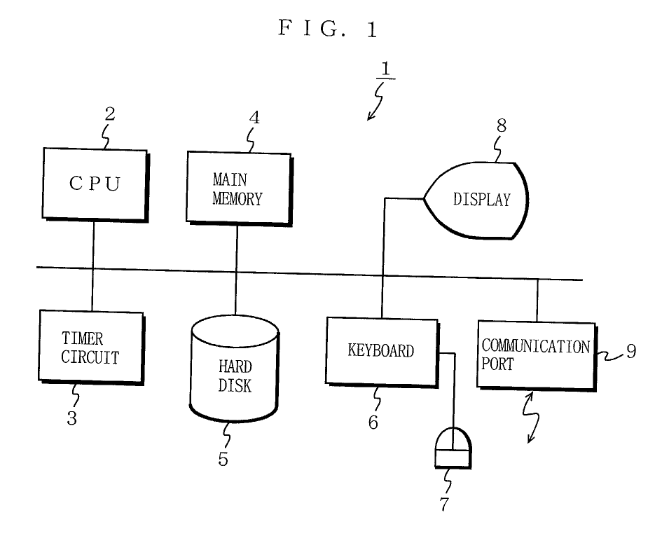

FIG. 1 is a diagram showing the hardware construction of a computer system in which a real-time OS simulator according to a first embodiment of the present invention operates. A computer 1 shown in FIG. 1 includes a CPU 2, a timer circuit 3, main memory 4, a hard disk 5, a keyboard 6, a mouse 7, a display 8, and a communication port 9. The CPU 2 transfers a program stored in advance in the hard disk 5 to the main memory 5 for execution. The timer circuit 3 generates an interrupt signal at predetermined time intervals for output to the CPU 2. Following an instruction provided by a user through the keyboard 6 or the mouse 7, the computer 1 carries out screen display on the display 8. The computer 1 also carries out data communications with other computers and components via the communication port 9. The computer 1 is equipped with a general-purpose multi-thread OS. Each thread that runs on the general-purpose OS can suspend or resume itself or another thread in arbitrary timing. Assume herein that the general-purpose OS has an event capability that enables each thread to generate a specific event or wait until a specific event occurs.

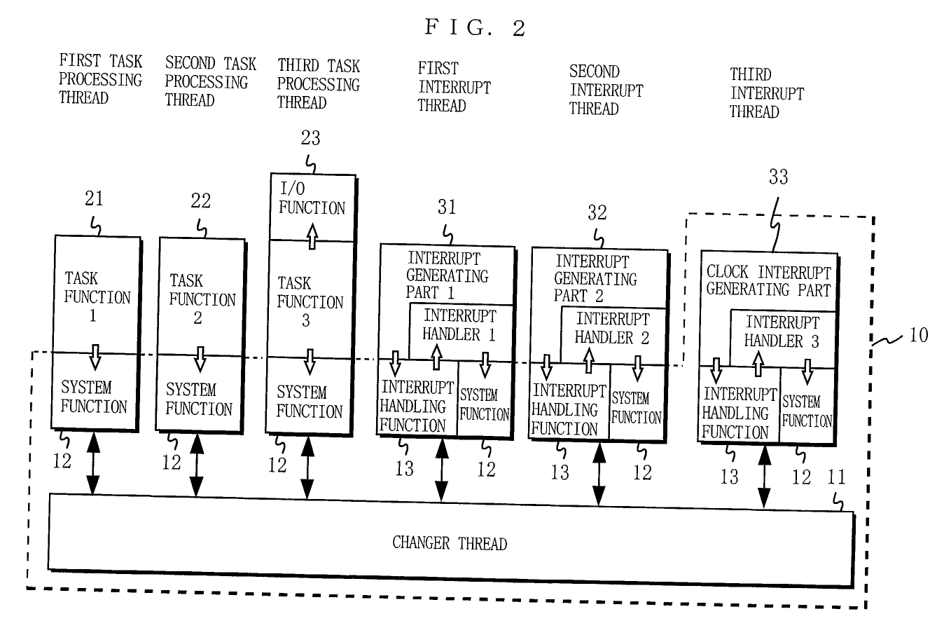

FIG. 2 is a diagram showing the software configuration of the real-time OS simulator according to the first embodiment of the present invention. In a real system, a plurality of tasks run concurrently on the real-time OS, and a plurality of interrupts occur asynchronously. In a real-time OS simulator 10, one task in the real system is related to one thread that runs on the general-purpose OS (hereinafter referred to as task processing thread). Similarly, one interrupt in the real system is related to one thread that runs on the general-purpose OS (hereinafter referred to as interrupt thread).

In the real-time OS simulator 10 of FIG. 2, exemplarily shown are first to third task processing threads 21 to 23 corresponding to three tasks and first to third interrupt threads 31 to 33 corresponding to three interrupts, all threads running concurrently. Each of the task processing threads 21 to 23 calls each different task function that actually carries out the task work in the real system. In some cases, the task processing thread calls a debugging-purpose input/output function (I/O function) for carrying out input/output to/from a storage or I/O device in the computer 1. For example, by calling I/O functions supported by the real-time OS, the task processing thread reads data form the hard disk 5, or causes the display 8 to display the data.

The interrupt threads 31 to 33 each generate a pseudo-interrupt to simulate an interrupt in the real system. Each interrupt thread includes an interrupt handler that corresponds to the interrupt. When to generate the pseudo-interrupt is given by an input device of the computer 1 or the like, and is supplied to each interrupt thread through the capabilities of the general-purpose OS. For example, the pseudo-interrupt is generated when a timer interrupt is generated by the timer circuit 3, when a user operates the keyboard 6 or the mouse 7, or when data is transmitted and/or received through the communication port 9. In the present embodiment, assume that the interrupt thread 33 is a system clock interrupt thread for causing a pseudo-interrupt that corresponds to a system clock interrupt.

The real-time OS simulator 10 includes a changer thread 11, system functions 12, interrupt handling functions 13, and a system clock interrupt thread 33. The system function 12 is called from the corresponding one of task processing threads 21 to 23 in the same manner as that when the real-time OS is called from the task in the real system. The interrupt handling function 13 is called when the corresponding one of the interrupt threads 31 to 33 generates a pseudo-interrupt. The changer thread 11 runs concurrently with the task processing threads 21 to 23 and the interrupt threads 31 to 33. The changer thread 11, the system functions 12, and the interrupt handling functions 13 call thread suspend/resume capability and event capability, as will be described below, thereby controlling the running of threads.

The real-time OS simulator 10 is transferred, together with the task functions and the interrupt handlers, to the main memory 4, and executed by the CPU 2. Thus, the task processing threads 21 to 23 corresponding to the tasks in the real system can carry out data input/output to/from the hard disk 5 and the display 8. Moreover, the pseudo-interrupt can occur while the task processing threads are running. As such, by executing the software shown in FIG. 2 on the computer 1 shown in FIG. 1, the user can debug the task functions and the interrupt handlers included in the application software in the real system.

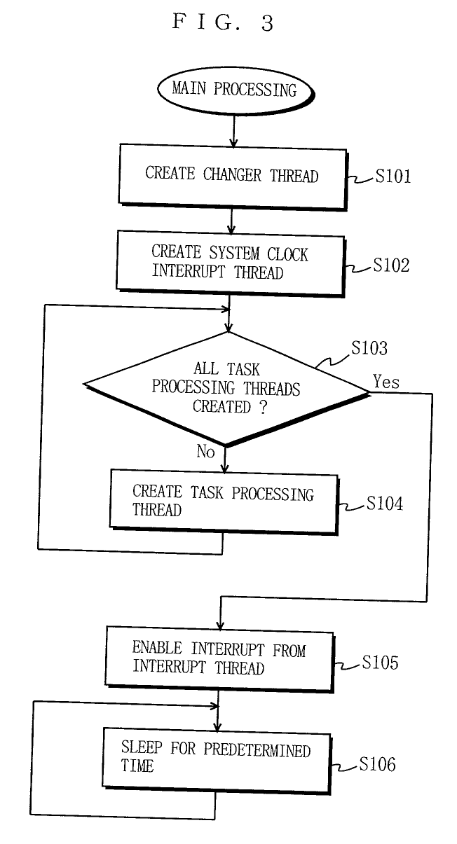

Hereinafter, the software configuring the real time OS simulator 10 is described in detail. FIG. 3 is a flowchart showing main processing of the real-time OS simulator 10. The real-time OS simulator 10 is given in advance task functions corresponding to the tasks in the real system and interrupt handlers also in the real system. First, the real-time OS simulator 10 creates the changer thread 11 and the system clock interrupt thread 33 (steps S101, S102). Then, the real-time OS simulator 10 sequentially creates task processing threads corresponding to the given task functions (steps S103, S104). Then, the real-time OS simulator 10 enables an interrupt from the interrupt thread (step S105), and thereafter repeats sleeping for a predetermined time (step S106). After step S106, the seven threads shown in FIG. 2 start to run concurrently. The subsequent capabilities of the real-time OS simulator 10 are realized by the changer thread 11, the system functions 12, and the interrupt handling functions 13.

The real-time OS simulator 10 mainly operates as follows. For switching to the next task at the time of calling the system function 12, each of the task processing threads 21 to 23 selects the task processing thread to run next, instructs the changer thread 11 to start dispatch processing, and then suspends itself. The interrupt threads 31 and 33 run concurrently with other threads, calling the interrupt handling function 13 when causing a pseudo-interrupt. The interrupt thread that calls the interrupt handling function 13 suspends the currently running thread, and records itself as the running thread. Thereafter, the interrupt thread calls the corresponding interrupt handler, and then selects the thread to run next for resuming. In order to establish synchronization among threads, two types of events are utilized. A first event is for the task processing threads 21 to 23 to instruct the changer thread 11 to start dispatch processing. A second event is for the changer thread 11 and the interrupt threads to notify the other threads that dispatch processing and interrupt handling are now enabled to start.

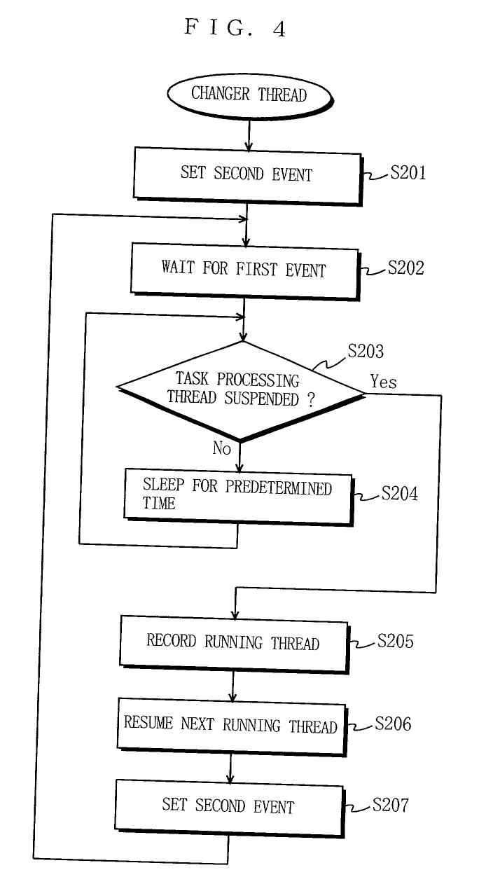

FIG. 4 is a flowchart showing the operation of the changer thread 11. The changer thread 11 first sets the second event (step S201), and then repeats the processing from steps S202 thorough S207. The changer thread 11 enters the waiting state for the first event that instructs the changer thread 11 to start dispatch processing (step S202). After the first event is set, the procedure goes to step S203. The changer thread 11 then repeats sleeping for a predetermined time until the running task processing thread is suspended (steps S203, S204). Thus, it is ensured that the changer thread 11 does not run while the task processing thread is running. After the running task processing thread is suspended, the changer thread 11 records the task processing thread selected to run next as the running thread (step S205), and resumes the selected task processing thread (step S206). The changer thread 11 then sets the second event indicating that dispatch processing and interrupt handling are enabled to start (step S207). The procedure then returns to step S202.

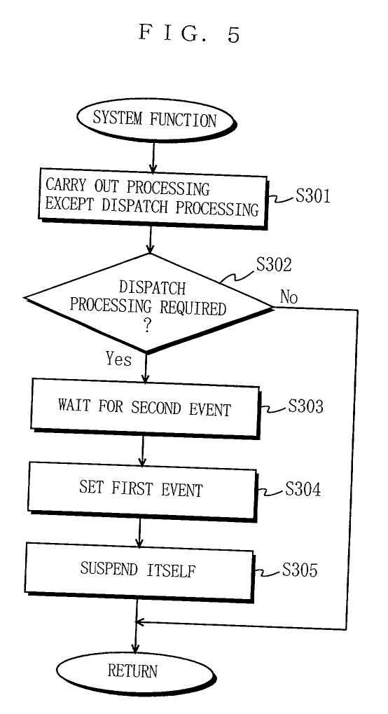

FIG. 5 is a flowchart showing the operation of the system function 12 called from the task processing thread. The task processing thread that called the system function carries out any processing provided by the real-time OS except thread dispatching processing (step S301). For example, in task switching processing in the real-time OS, the running task is moved to the tail of a runnable task queue, and the task located at the head thereof is changed to the running state. Correspondingly, the processing similar to that in step S301 is also carried out in the real-time OS simulator 10. Then, the task processing thread determines whether dispatch processing should be carried out or not as a result of the processing in step S301 (step S302). If Yes, the task processing thread carries out steps S303 to S305.

If dispatch processing should be carried out, the task processing thread first enters the waiting state for the second event, waiting until the changer thread 11 is enabled to start dispatch processing (step S303). After the changer thread 11 is enabled to start the dispatch processing, the task processing thread sets the first event that instructs the changer thread 11 to start the dispatch processing (step S304), and suspends itself (step S305). Thus, the task processing thread is suspended in step S305 and thereafter, and the changer thread 11 runs.

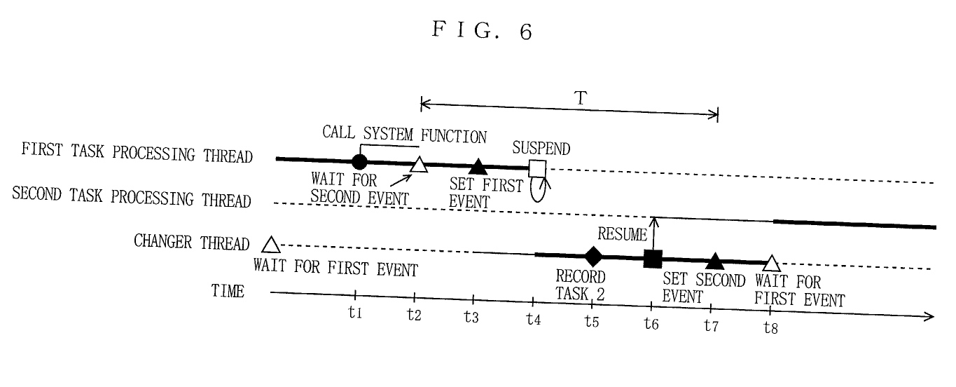

FIGS. 6 to 8 are exemplary timing charts of dispatch processing carried out by the real-time OS simulator according to the present embodiment. In these timing charts, each line in the horizontal direction represents one thread. A thick line represents that the thread is in a running state; a narrow line represents that the thread is in a runnable state; and a broken lines represents in a suspended or waiting state. ● represents calling the system function; ▴ represents setting an event; Δ represents waiting for an event; □ represents suspending the thread, ▪ represents resuming the thread; and ♦ represents recording the running thread.

FIG. 6 is one exemplary timing chart of dispatch processing corresponding to the switching from a first task to a second in the real system. Assume that, in the initial state, the changer thread is in the waiting state for the first event (step S202), and a first task processing thread is running. The first task processing thread calls the system function at a time t1, and then carries out processing except dispatch between the time t1 and a time t2 (step S301). The first task processing thread then determines that dispatch processing should be carried out (step S302), and enters the waiting state for the second event at the time t2 (step S303). Until then, the second event has been set, and therefore the procedure immediately goes to step S304, wherein the first task processing thread sets the first event at a time t3. With this, the changer thread enters the runnable state after the time t3.

In the timing chart shown in FIG. 6, the first task thread runs continuously, and suspends itself at a time t4 (step S305). When the first task processing thread is suspended at the time t4, the changer thread records, at a time t5, a second task processing thread as the running thread (step S205), and resumes the second task processing thread at a time t6 (step S206). Therefore, the second task processing thread is in the runnable thread after the time t6. The changer thread sets the second event at a time t7, and notifies the other threads that dispatch processing is enabled to start (step S207). Then, the changer thread enters the waiting state for the first event at a time t8 (step S202). Therefore, the second task processing thread runs after the time t8. As such, dispatching processing from the first task processing thread to the second is carried out. The time required for dispatch is between the time t2 and the time t7, as indicated by a period T in FIG. 6.

In the timing chart shown in FIG. 6, two threads are simultaneously in the runnable state between the time t3 and the time t4 and between the time t6 and the time t8. In this case, which thread is to run depends on the thread scheduling algorithm provided by the general-purpose OS.

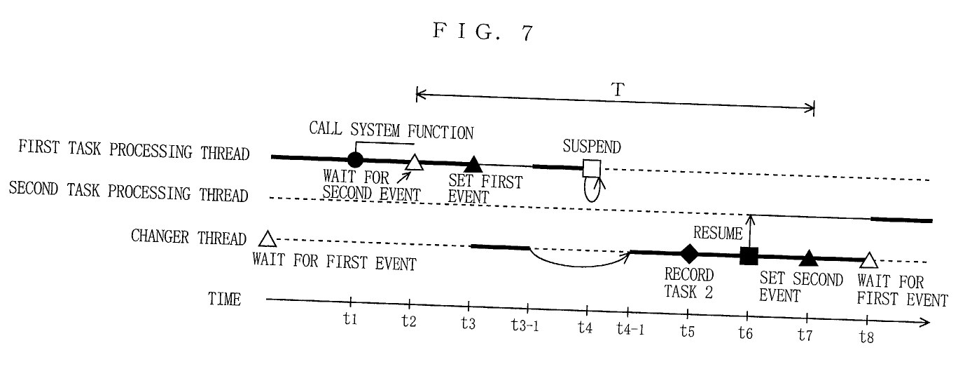

FIG. 7 is another exemplary timing chart when the changer thread runs after the time t3. In this case, the changer thread repeats sleeping for a predetermined time until the running task processing thread is suspended (steps S203, S204). The changer thread enters a sleep state at a time t3-1 and, thereafter, the first task processing thread runs again. The first task processing thread suspends itself at the time t4 (step S305). The changer thread then comes out from the sleep state at a time t4-1, and carries out steps S205 through S207. Therefore, the timing chart after the time t4-1 shown in FIG. 7 coincides with that shown in FIG. 6. As such, the changer thread repeats sleeping until the running task processing thread is suspended. Therefore, the dispatch processing in the real-time OS can be simulated irrespectively of the thread scheduling algorithm provided by the general-purpose OS.

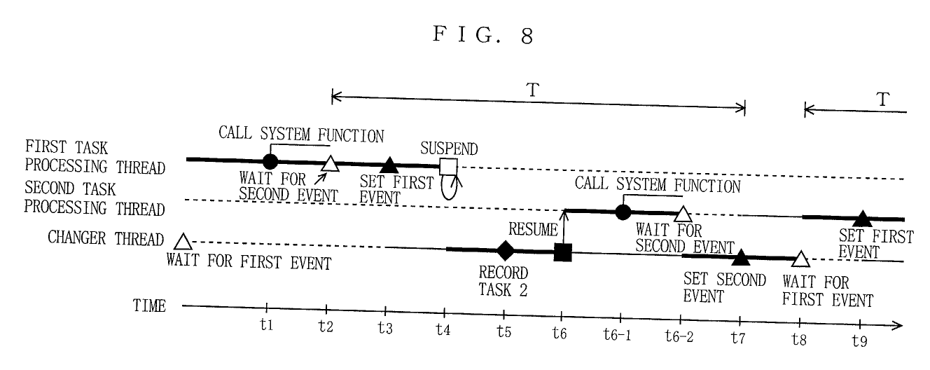

FIG. 8 is still another exemplary timing chart when the second task processing thread runs after the time t6. The timing chart from the initial state to the time t6 shown in FIG. 8 coincides with that shown in FIG. 6. The second task processing thread resumed at the time t6 calls the system function at a time t6-1, and then enters the waiting state for the second event at a time t6-2 (step S303). Therefore, the changer thread runs again, and sets the second even at a time t7 (step S207). As such, the use of the event capability provided by the general-purpose OS prevents a plurality of task processing threads from simultaneously instructing the changer thread to carry out dispatch processing. Therefore, the changer thread can surely carry out dispatch processing.

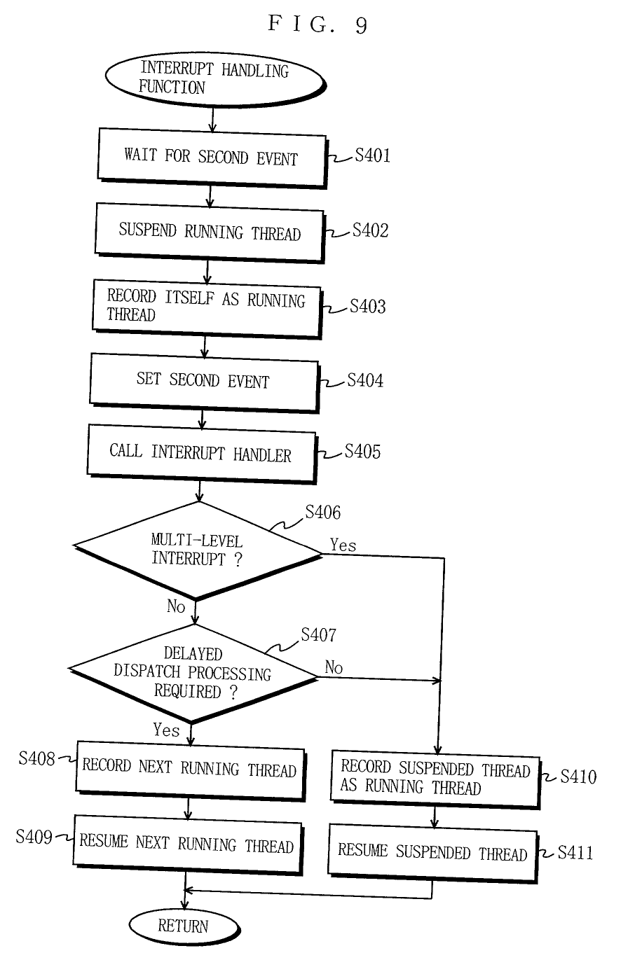

FIG. 9 is a flowchart showing the operation of the interrupt handling function 13 called from the interrupt thread. The interrupt thread that called the interrupt handling function first enters the waiting state for the second event, waiting until the changer thread is enabled to start interrupt handling (step S401). After the changer thread is enabled to start interrupt handling, the interrupt thread suspends the running thread (step S402). The thread to be suspended in step S402 is either any task processing thread or any other interrupt thread. The interrupt thread then records itself as the running thread (step S403). The interrupt thread then sets the second event, and notifies the other threads that the interrupt handling is enabled to start (step S404). The interrupt thread then calls the interrupt handler corresponding to its own interrupt (step S405).

After the processing of the interrupt handler ends, the interrupt thread checks whether multi-level interrupt handling and delayed dispatch processing should be carried out (steps S406, S407). If delayed dispatch processing should be carried out but multi-level interrupt handling should not, the interrupt thread records the task processing thread to run next as the running thread (step S408), and resumes that thread (step S409) Otherwise, the interrupt thread records the thread suspended in step S402 as the running thread (step S410), and resumes that thread (step S411).

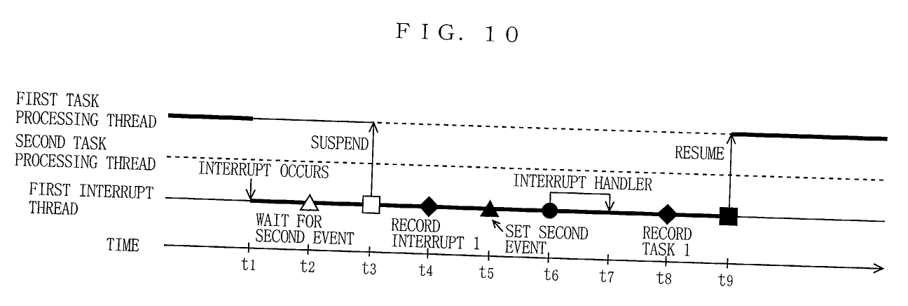

FIGS. 10 through 13 show exemplary timing charts of interrupt handling carried out by the real-time OS simulator according to the present embodiment. These figures are illustrated in the same notation as that in FIG. 6.

FIG. 10 is one exemplary timing chart in a case where a first interrupt occurs while the first task processing thread is running. Assume that, at the initial state, the second event has been set and the first task processing thread is running. Also assume that the first interrupt thread is in the runnable state at the initial state, and calls for the interrupt handling function at the time t1. After the time t1, the first interrupt thread operates by following the flowchart shown in FIG. 9. First, the first interrupt thread enters the waiting state for the second event at the time t2 (step S401). Until then, the second event has been already set, and therefore the procedure immediately goes to step S402, wherein the first interrupt thread suspends, at the time t3, the running thread, that is, the first task processing thread (step pS402). Therefore, the first task processing thread is in a suspended state.

Then, the first interrupt thread records itself as the running thread at the time t4 (step S403), and sets the second event at the time t5 (step S404). Therefore, any other interrupt handling is enabled to start after the time t5. Furthermore, the first interrupt thread calls the interrupt handler corresponding to its own interrupt between the time t6 and the time t7 (step S405). The first interrupt thread then determines that neither multi-level interrupt handling nor the delayed dispatch processing should be carried out (steps S406, S407). The procedure then goes to step S410. Finally, the first interrupt thread records, at the time t8, the first task processing thread suspended in step S402 as the running thread (step S410), and resumes that thread at the time t9 (step S411). Thus, the first task processing thread runs again. As such, the interrupt thread that called the interrupt handling function suspends the running task processing thread, and resumes the suspended task processing thread after calling the interrupt handler. Therefore, the interrupt handling of the real-time OS can be simulated.

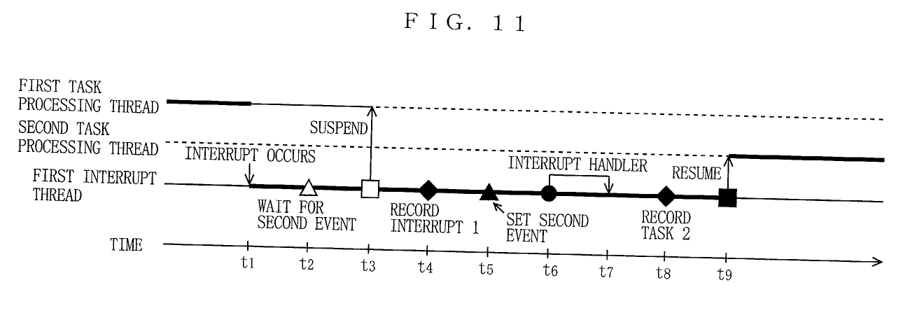

FIG. 11 is an exemplary timing chart of delayed dispatch processing. The timing chart between the initial state and the time t7 shown in FIG. 11 coincides with that shown in FIG. 10. For the delayed dispatch processing, the procedure goes from step S407 to step S408. Then, the first interrupt thread records, at the time t8, the second task processing thread as the running thread (step S408), and resumes that thread at the time t9 (step S409). Thus, after the time t9, the second task processing thread runs instead of the first task processing thread. As such, by resuming the task processing thread except the suspended one, the delayed dispatch processing of the real-time OS can be simulated.

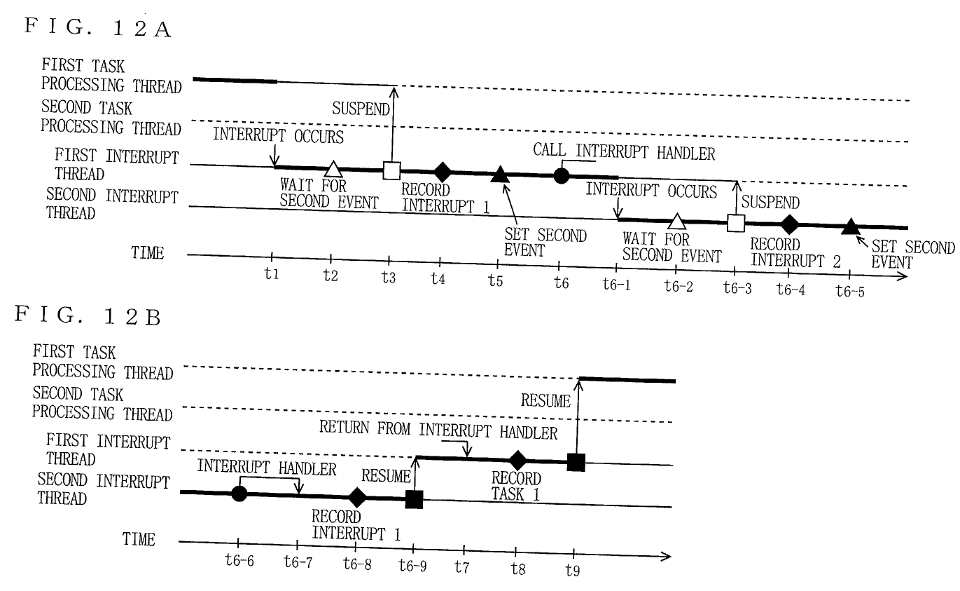

FIGS. 12A and 12B show exemplary timing charts of multi-level interrupt handling. The timing chart shown in FIG. 12A is followed by that shown in FIG. 12B in time. The timing chart between the initial state and a time t6-1 shown in FIG. 12A coincides with that shown in FIG. 10. After the interrupt thread notifies the other threads at the time t5 that the interrupt handling is enabled to start, assume that the second interrupt thread calls the interrupt handling function at the time t6-1. The second interrupt thread suspends, at a time t6-3, the preceding running thread, that is, the first interrupt thread (step S402), and carries out the processing from steps S403 through S405 between the time t6-3 and a time t6-7 The second interrupt thread then determines that the multi-level interrupt handling is being carried out (step S406), and the procedure then goes to steps S406 to S410. Finally, the second interrupt thread records, at a time t6-8, the first interrupt thread as the running thread (step S410), and resumes that thread at a time t6-9 (step S411). Thereafter, the resumed first interrupt thread operates similarly to a case where no interrupt from the second interrupt thread occurs. As such, if one interrupt thread is running when another interrupt occurs, the interrupt thread is suspended, and the interrupt handler corresponding to the subsequent interrupt is called. Therefore, the multi-level interrupt handling of the real-time OS can be simulated.

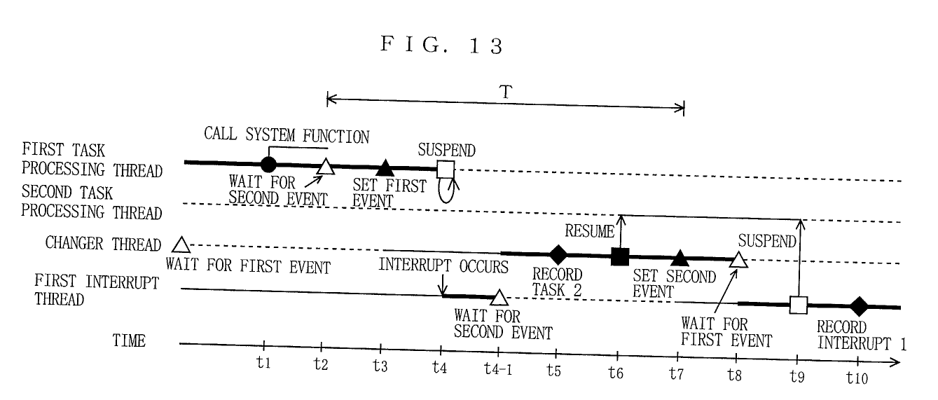

FIG. 13 is an exemplary timing chart of interrupt handling when an interrupt occurs while dispatch processing is being carried out. This timing chart exemplifies a case where the first interrupt thread calls the interrupt handling function at the time t4 in FIG. 6. The first interrupt thread enters the waiting state for the second event at a time t4-1 (step S401). Therefore, the changer thread runs after the time t4-1. The first interrupt thread enters the runnable state after the changer thread sets the second event at the time t7, and then runs after the changer thread enters the waiting state for the first event. As such, with exclusive control by using the second event, the interrupt handling during dispatch processing in the real-time OS can be simulated.

The system clock interrupt thread 33 generates a pseudo-interrupt corresponding to a system clock, and includes an interrupt handler that handles a system clock interrupt. With such interrupt thread, timer management capability of the real-time OS in the real system can be simulated.

As stated above, in the real-time OS simulator according to the present embodiment, the task processing thread selects, when calling the system function, the task processing thread to run next, instructs the changer thread to start dispatch processing, and then suspends itself. The changer thread, on the other hand, when instructed to start the processing, suspends the preceding running task processing thread and then resumes the selected task processing thread for processing next. Thus, the dispatch processing of the real-time OS can be simulated irrespectively of the thread scheduling algorithm provided by the general-purpose OS. Moreover, the task processing thread instructs the changer thread to start processing after the changer thread is enabled to start dispatch processing, thereby preventing a plurality of task processing threads from simultaneously instructing dispatch processing. Still further, when calling the interrupt handling function, the interrupt thread suspends the running thread, calls the interrupt handler that corresponds to the task processing thread to run next, and then resumes the task processing thread. Thus, the interrupt handling and the delayed dispatch processing of the real-time OS can be simulated. Still further, also when an interrupt occurs while the interrupt thread is running, the interrupt thread suspends the running interrupt thread, and resumes the suspended interrupt thread after calling the interrupt handler corresponding to the subsequent interrupt. Thus, the multilevel interrupt handling in the real-time OS can be simulated. As such, the real-time OS simulator according to the present embodiment can simulate the capabilities of the real-time OS required for developing multi-task software to run on the real-time OS.

### Second Embodiment

A real-time OS simulator according to a second embodiment of the present invention has the same software configuration as that of the real-time OS simulator according to the first embodiment, except the changer thread and part of the system functions. The real-time OS simulator according to the present embodiment operates also on a general-purpose OS that prohibits the thread from suspending itself. This real-time OS simulator uses a third event provided for each task processing thread and indicating that the task processing thread is in the waiting state.

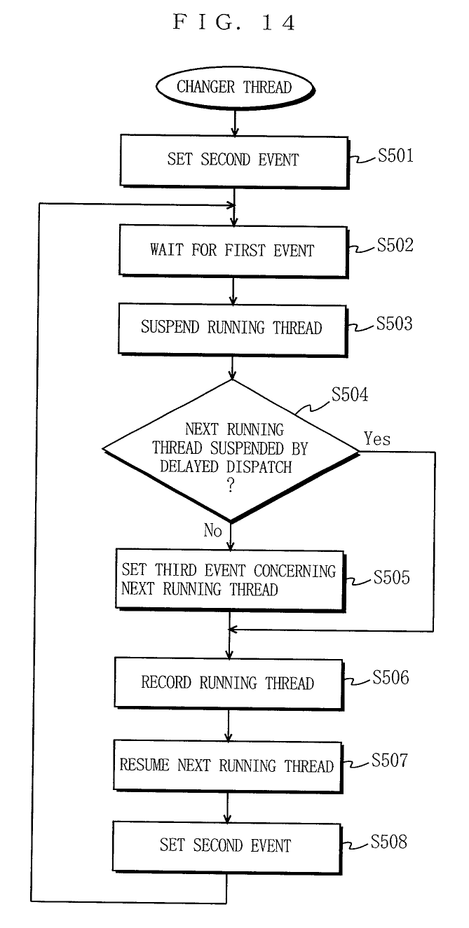

FIG. 14 is a flowchart showing the operation of the changer thread 11 according to the present embodiment. As shown in FIG. 4, the changer thread according to the first embodiment repeats sleeping for the predetermined time until the running task processing thread is suspended (steps S203, S204). The changer thread according to the second embodiment, on the other hand, is characterized as suspending the running task processing thread (step S503).

In the flowchart shown in FIG. 14, the processing except steps S503 to S505 are the same as that shown in FIG. 4, and therefore not described here. After the first event instructing the changer thread to start dispatch processing is set (step S502), the changer thread suspends the running task processing thread (step S503). The changer thread then determines whether the task processing thread to run next is suspended by the delayed dispatch processing due to interrupt (step S504). If Yes, the third event concerning the task processing thread to run next is set (step S505).

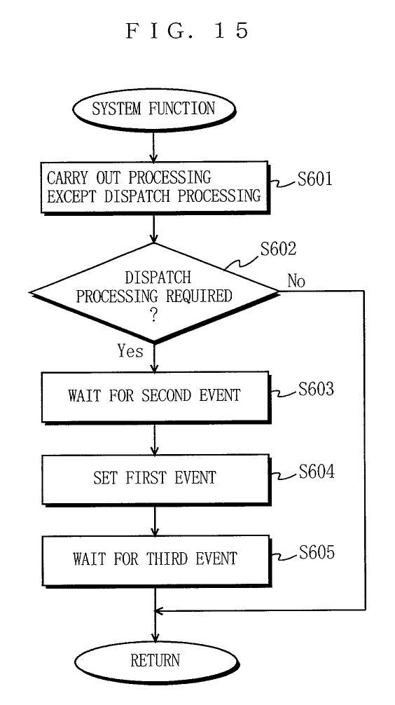

FIG. 15 is a flowchart showing the operation of the system function 12 called from the task processing thread. The processing from steps S601 through S604 in this flowchart is the same as that from steps S301 through S304 in the flowchart shown in FIG. 5, and therefore not described here. The task processing thread that has called the system function enters, in step S605, the waiting state for the third event concerning its own thread.

As such, the task processing thread first instructs the changer thread to start the processing, and then enters the waiting state for the third event. When instructed as the above, the changer thread suspends the running task processing thread. Therefore, the dispatch processing of the real-time OS can be simulated even when a general-purpose multi-thread OS prohibiting a thread from suspending itself is used.

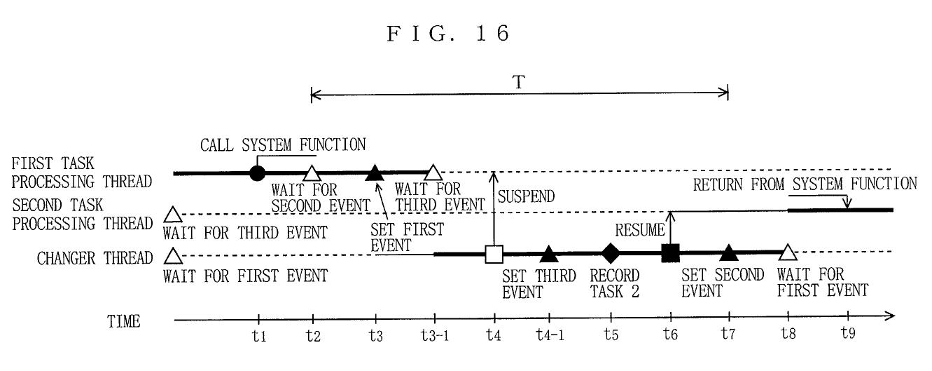

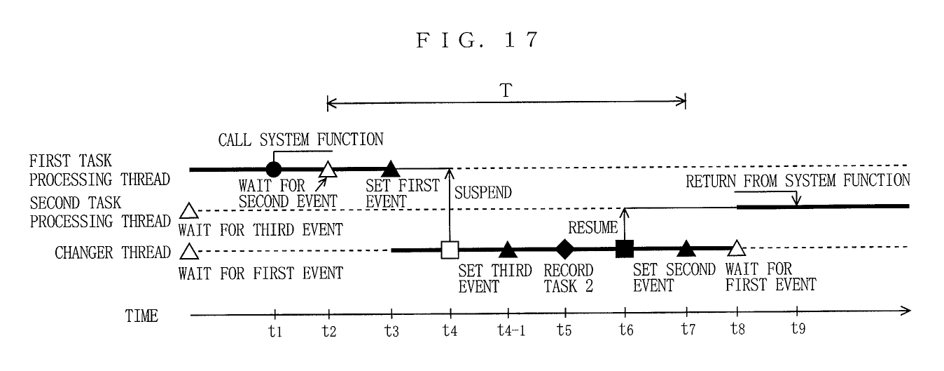

FIGS. 16 and 17 are exemplary timing charts of dispatch processing carried out by the real-time OS simulator according to the present embodiment. The timing charts in FIGS. 16 and 17, illustrated in the same notation as that in FIG. 6, correspond to those in FIGS. 6 and 7, respectively. Assume herein that the second event has been set at the initial state. Also assume that the changer thread is in the waiting state for the first event (step S502), and the second task processing thread is in the waiting state for the third event within the system function (step S605).

In the timing chart of FIG. 16, the first task processing thread calls the system function at the time t1, sets the first event at the time t3 (step S604), and then enters the waiting state for the third event at a time t3-1 (step S605). This causes the changer thread to run at the time t3-1. The changer thread suspends the first task processing thread at the time t4 (step S503). The changer thread then determines whether the task processing thread to run next has been suspended by the delayed dispatch processing (step S504). In this example, the procedure goes to from step S504 to step S505, wherein the changer thread sets the third event concerning the second task processing thread at a time t4-1 (step S505). This causes, at the time t4-1, the second task processing thread to come out from the waiting state for the third event and then to be suspended. The changer thread then, at the time t5, records the second task processing thread as the thread to run next (step S506), and resumes the second task processing thread at the time t6 (step S507). This causes the second task processing thread to be in the runnable state after the time t6. Furthermore, the changer thread sets the second event at the time t7 (step S508), and then enters the waiting state for the first event (step S502). This causes the second task processing thread to run at the time t8.

FIG. 17 is an exemplary timing chart when the changer thread runs after the time t3. This timing chart is different from that of FIG. 16 only in that the changer thread suspends the first task processing thread at the time t4 (step S503).

Note that, in the timing charts of FIGS. 16 and 17, if the second task processing is not in the waiting state for the third event, the procedure goes from step S504 to step S506, and the changer thread does not set the third event concerning the second task processing thread.

As stated above, in the real-time OS simulator according to the present embodiment, the task processing thread instructs the changer thread to start the processing, and then enters the waiting state. When instructed as the above, the changer thread suspends the running task processing thread, and then releases it, if the task processing thread to run next is in the waiting state, from the waiting state for resuming. Therefore, the dispatch processing of the real-time OS can be simulated even when a general-purpose multi-thread OS prohibiting a thread from suspending itself is used.

Note that, if a general-purpose multi-thread OS on which threads run according to specific priorities is used, the scheduler thread may be given a higher priority to the task processing thread. In this case, even if the processing for the third event is deleted from the flowcharts shown in FIGS. 14 and 15, the scheduler thread runs prior to the task processing thread, thereby achieving the same effects of the present embodiment.

### Third Embodiment

A real-time OS simulator according to a third embodiment of the present invention is constructed by adding a capability of simulating task exception handling to the real-time OS simulator according to the first embodiment. The task exception handling is a capability of handling an exception occurred on a task in its context, and adopted by μ ITRON (Micro Industrial The Real-time Operating System Nucleus) Ver. 4.0. In a real-time OS supporting such task exception handling, an exception handler is defined for each task, and each task can request any other task to carry out task exception handling. The task requested to carry out task exception handling suspends the running processing, and executes the task exception handler in the same context as that of the suspended processing.

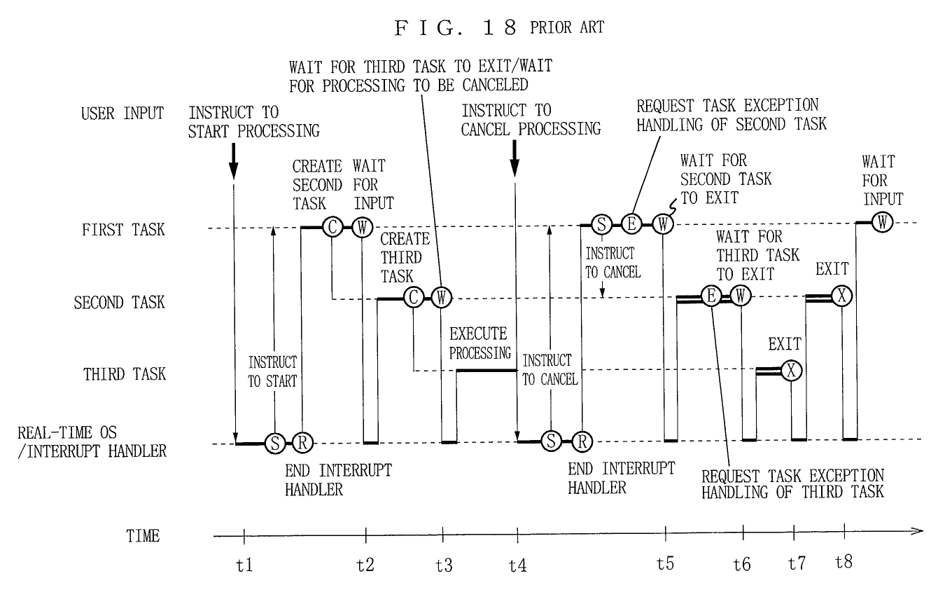

FIG. 18 is an exemplary timing chart showing how tasks are switched by the real-time OS that supports task exception handling. In FIG. 18, a horizontal line represents one task. A thick line represents that the task is executing normal processing; a double line represents that the task exception handling is being executed; and a broken line represents that the task is being suspended. A blank portion represents that the task does not exist. ◯ represents that the system function that affects task switching is called. Note that a higher priority is given to the first task, then the second task, and then the third task.

In the real-time OS that supports task exception handling, task switching is carried out as follows. When the user provides an instruction input for starting processing, a first task waiting for an input from the user creates a second task carrying out lower processing, and then again enters the waiting state for an input from the user. The second task creates a third task carrying out further lower processing, and then enters the waiting state for the third task to exit or the waiting state for the processing to be canceled. When an instruction for canceling is provided while the third task is running, the first task instructs the second task to cancel the processing, and comes out from the waiting state for the second task. Then, the first task carries out task exception handling, and then enters the waiting state for the second task to exit. Requested to carry out task exception handling, the second task further requests, within the exception handler of its own, the third task to carry out task exception handling, and enters the waiting state for the third task to exit. Requested to carry out task exception handling, the third task carries out, within the exception handler of its own, memory deallocation and other processing, and then exits. When the third task exits, the second task exits. As a result, the first task processing runs there after. As such, by suspending the task by task exception handling, needless processing can be eliminated, and the efficiency of the real system can be improved.

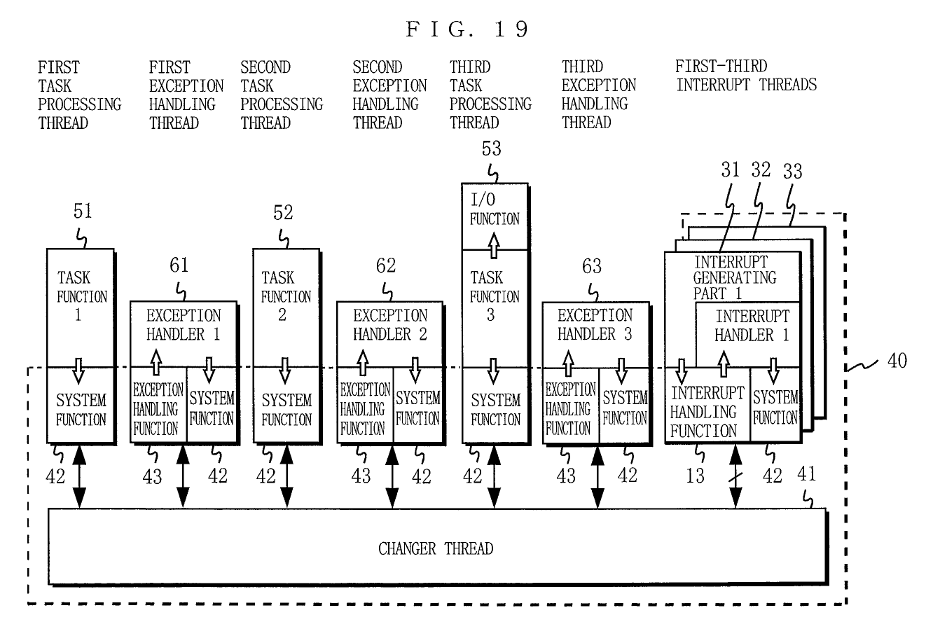

FIG. 19 is the software configuration of the real-time OS simulator according to the third embodiment of the present invention. As shown in FIG. 19, a real-time OS simulator 40 includes a changer thread 41, system functions 42, exception handling functions 43, and interrupt handling functions 13. In the real-time OS simulator 40, each task in the real system is related to two threads (task processing thread and exception handling thread) to run on a general-purpose OS. Of these two threads, the exception handling thread is the one provided in the present embodiment for simulating task exception handling of the real-time OS. The interrupt handling in the present embodiment is the same as that in the first embodiment. Therefore, in the present embodiment, the same components as those in the first embodiment are provided with the same reference numerals, and not described herein.

FIG. 19 exemplarily shows the real-time OS simulator 40, wherein three tasks correspond to first to third task processing threads 51 to 53 and first to third exception handling threads 61 to 63, and three interrupts correspond to first to third interrupt threads 31 to 33. All of these threads run concurrently. As described above, each task in the real system corresponds to one task processing thread and one exception handling thread. For example, the first task in the real system corresponds to the first task processing thread 51 and the first exception handling thread 61.

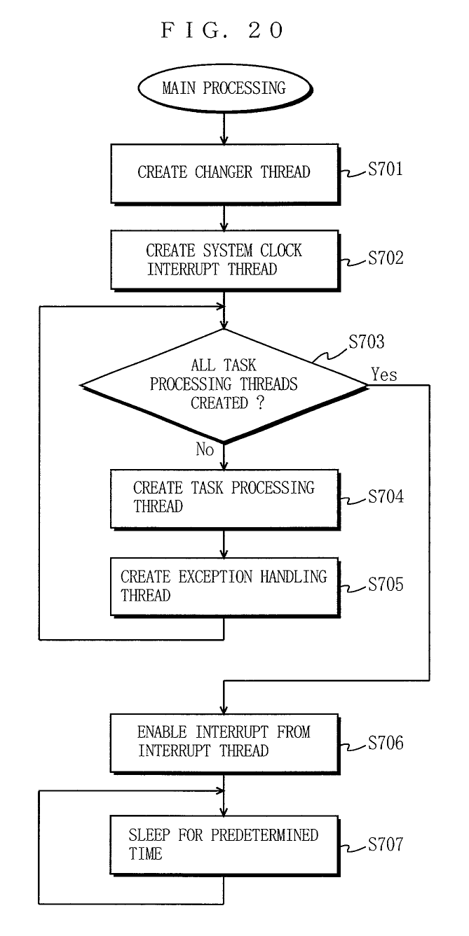

FIG. 20 is a flowchart showing main processing of the real-time OS simulator 40. In the flowchart shown in FIG. 20, the processing except step S705 is the same as that in FIG. 3, and therefore not described herein. In addition to the task functions and the interrupt handlers, the real-time OS simulator 40 is provided with exception handlers for the tasks. These exception handlers are the same as those called when task exception handling is requested in the real system. The real-time OS simulator 40 creates, every time it creates the task processing thread corresponding to a task (step S704), the exception handling thread for calling the exception handler for that task (step S705). After step S707, all of those ten threads shown in FIG. 19 start to run concurrently.

For simulating task exception handling, the real-time OS simulator 40 uses three flags, that is, an exception handling request flag, exception handling enable flag, and exception handling state flag. The exception handling request flag indicates whether task exception handling is requested for the task or not. The exception handling enable flag indicates whether task exception handling is enabled for the task or not. The exception handling state flag indicates whether the task is executing task exception handling or not. The exception handling request flag and the exception handling enable flag are set in the system function 42 and the exception handling function 43, while the exception handling state flag is set in the exception handling thread. The changer thread 41 refers to these flags to select the thread to run next.

The task processing threads 51 to 53 each execute normal task processing similarly to the first embodiment. The system function 42 is called from each of the task processing threads 51 and 53 in a manner similar to that when the real-time OS is called from the task in the real system. The system function 42 according to the present embodiment is characterized as including task exception handling functions that can be called in a manner similar to that in the real-time OS. The flowchart of the operation of the system function 42 is the same as that shown in FIG. 5. The above three flags are set in step S301 of FIG. 5. For example, the exception handling request flag is set ON in step S301 of a function for requesting task exception handling. The exception handling enable flag is set ON in step S301 of a function for enabling task exception handling, and OFF in step S301 of a function for disabling task exception handling.

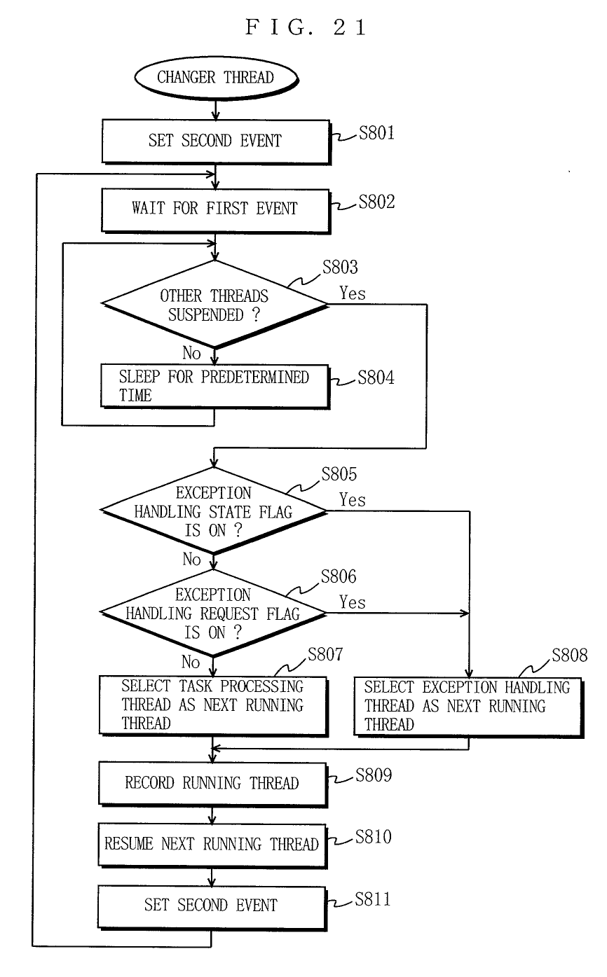

FIG. 21 is a flowchart showing the operation of the changer thread 41. In the flowchart of FIG. 21, the processing except steps S805 to S808 is the same as that in FIG. 4, and therefore not described herein. After all task processing threads and exception handling threads are suspended, the procedure goes to step S805 (step S803). Until then, the task to run next (hereinafter referred to as next task) has been determined by the processing except dispatch of the system function 42 (step S301). If the exception handling state flag or the exception handling request flag is ON (steps S805, S806) the changer thread 41 selects the exception handling thread corresponding to the next task as the thread to run next (step S808). Otherwise, the changer thread 41 selects the task processing thread corresponding to the next task as the thread to run next (step S807). Note that, if the exception handling enable flag is OFF in step S806, the procedure goes to step S807. As such, the changer thread 41 selects one of the two threads corresponding to the next task as the thread to run next.

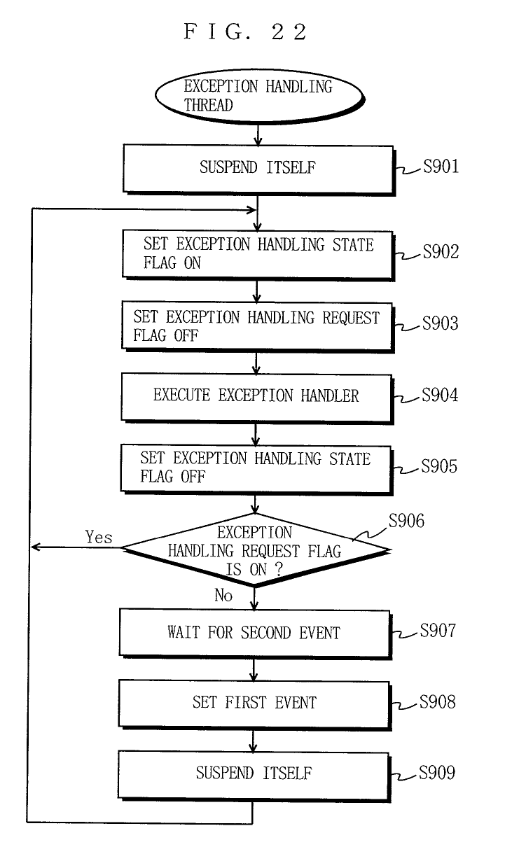

The exception handling threads 61 to 63 each call the exception handler for the task to execute task exception handling. The real-time OS simulator 40 includes the exception handling functions 43 for carrying out the main processing of the exception handling threads 61 to 63. FIG. 22 is a flowchart of the main processing (that is, the exception handling function 43) in the exception handling thread. The main processing is the same among the exception handling threads 61 to 63 except that the exception handler to run in step S904 varies according to the task.

The exception handling thread suspends itself immediately after created (step S901). When resumed by the changer thread, the exception handling thread sets its exception handling state flag ON, indicating that task exception handling is being executed (step S902). Then, the exception handling thread sets its exception handling request flag from ON to OFF (step S902). Then, the exception handling threads calls the exception handler of its own (step S904). In the exception handler, predetermined processing that varies for each task is carried out. When returning from the exception handler, the exception handling thread sets its exception handling state flag OFF, indicating that the task exception handling is not being executed (step S905).

In some cases, while the exception handling thread is executing the exception handler, another task requests the current task to carry out task exception handling. In such case, if the exception handling request flag of the task is ON when it returns from the exception handler (step S906), the procedure goes to step S902, wherein task exception handling is again carried out (step S906). Otherwise, the procedure goes to steps S907 and S908, and then the exception handling thread suspends itself (step S909). The processing from steps S907 through S909 is the same as that from steps S303 through S305 shown in the flowchart of FIG. 5, and therefore not described herein. After step S909, the changer thread runs, and if it resumes the exception handling thread, the procedure goes to step S902, and the task exception handling starts.

As such, in the real-time OS simulator 40, if a request for task exception handling is issued to one task, the changer thread 41 resumes the exception handling thread of that task. The resumed exception handling thread calls the exception handler previously provided. Therefore, the real-time OS simulator 40 can simulate the task exception handling of the real-time OS. Moreover, if the exception handler of one exception handling thread is running when another thread runs, the changer thread 41 can resume the former exception handling thread. Therefore, the real-time OS simulator 40 can simulate the multi-level task exception handling.

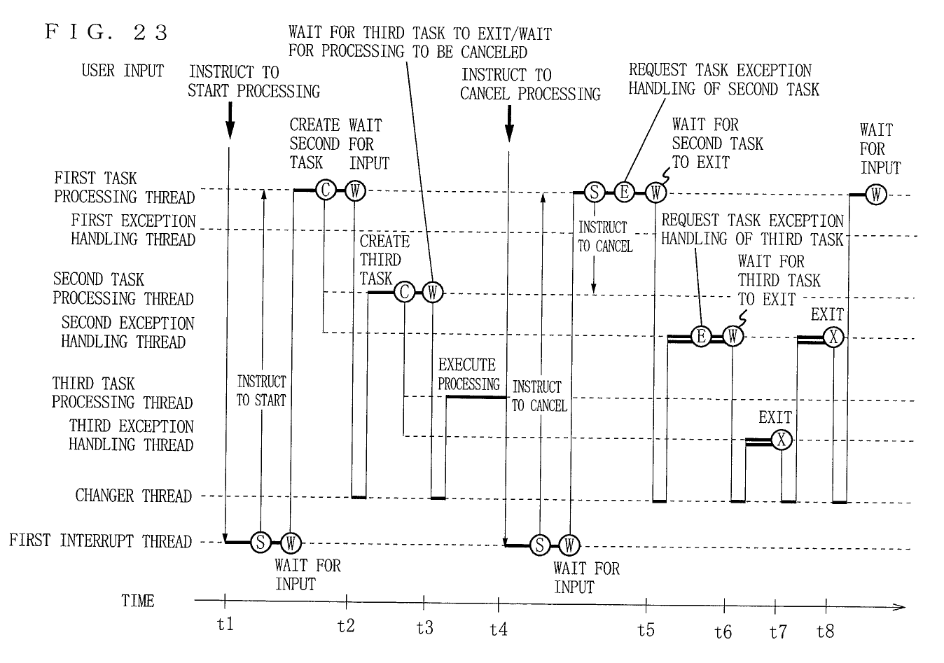

FIG. 23 is an exemplary timing chart of task exception handling by the real-time OS simulator 40, illustrating the states of eight threads (excluding interrupt threads 32 and 33) concurrently run on the real-time simulator 40 in the same notation as that used in FIG. 18. With reference to FIGS. 18 and 23, while normal processing of one task is carried out in the real system, the task processing thread corresponding to that task runs in the real-time OS simulator 40. While task exception processing of one task is carried out in the real system, on the other hand, the exception handling thread corresponding to that task runs in the real-time OS simulator 40. In the following description, assume that the first interrupt thread is a thread corresponding to an interrupt inputted by the user.

In an initial state, assume herein that the first task processing thread and the first interrupt thread are suspended in the waiting state for an input from the user, and the first exception handling thread is suspended in step S909. Also assume herein that the second and third task processing threads and the second and third exception handling threads are not exist. Still also assume that the exception handling flags of the tasks are all ON, and a higher priority is given to the first task, then the second task, and then the third task.

When the user provides an instruction input for starting processing at the time t1, the first interrupt thread monitoring a user's input runs. The first interrupt thread gives, in the interrupt handling (step S405), an instruction for starting processing by using the system function. Thus, the first task processing thread suspended in the waiting state for an input from the user enters the runnable state. Then, the first interrupt thread returns from the interrupt handler to resume the first task processing thread (step S411), and then is suspended again in the waiting state for an input from the user.

When resumed after the time t1, the first task processing thread calls the system function for creating the second task. Thus, the second task processing thread and the second exception handling thread are created, the former entering the runnable state and the latter being suspended in step S901. The second task is given a lower priority than the first task, and therefore the first task processing thread continues to run. Then, the first task processing thread is suspended at the time t2 in the waiting state for an input from the user. After the first task is suspended, the task to run next is the second task.

The changer thread detects at the time t2 that the exception handling state flag and the exception handling request flag of the second task are both OFF (steps S805, S806) Then, the changer thread selects the second task processing thread as the thread to run next (step S807) The changer thread resumes the second task processing thread (step S810), and then enters the waiting state for the first event (step S802).

When resumed at the time t2, the second task processing thread calls the system function for creating the third task. Thus, the third task processing thread and the third exception handling thread are created, the former entering the runnable state and the latter being suspended in step S901. The third task is given a lower priority than the second task, and therefore the second task processing thread continues to run. Then, the second task processing thread is suspended at the time t3 until the third task exits or an instruction for canceling processing is provided. After the second task is suspended, the task to run next is the third task.

The changer thread detects at the time t3 that the exception handling state flag and the exception handling request flag of the third task are both OFF (steps S805, S806). Then, the changer thread selects the third task processing thread as the thread to run next (step S807). The changer thread resumes the third task processing thread (step S810), and then enters the waiting state for the first event (step S802).

After the time t3, the third task processing thread carries out predetermined processing. An instruction input for canceling processing is provided by the user at the time t4, the first interrupt thread monitoring an input from the user runs. The first interrupt thread gives, in the interrupt handler (step S405), an instruction for canceling processing by using the system function. Thus, the first task processing thread suspended in the waiting state for an input from the user enters the runnable state. The first task is given the highest priority, and therefore the task to run next is the first task.

Then, the first interrupt thread returns from the interrupt handler, determining that the delayed dispatch processing is required (step S407). Based on the determination, the first interrupt thread resumes the first task processing thread (step S409), and is suspended in the waiting state for an input from the user.

When resumed after the time t4, the first task processing thread gives an instruction for canceling processing to the second task processing thread. Thus, the second task processing thread enters the runnable state. The second task is given a lower priority than the first task, and therefore the first task processing thread continues to run. Then, the first task processing thread requests, by using the system function, the second task to carry out task exception handling. Thus, the exception handling request flag of the second task is set ON. Then, at the time t5, the first task processing thread is suspended in the waiting state for the second task to exit. After the first task is suspended, the task to run next is the second task.

The changer thread detects at the time t5 that the exception handling request flag of the second task is ON (step S806), and selects the second exception handling thread as the next running thread (step S808). The changer thread then resumes the second exception handling thread (step S810), and then enters the waiting state for the first event (step S802).

When resumed at the time t5, the second exception handling thread sets its own exception handling state flag ON (step S902), and sets its own exception handling request flag OFF (step S903). The second exception handling thread then calls its own exception handler (step S904). In this exception handler, the second exception handling thread requests, by using the system function, the third task to carry out task exception handling. Thus, the exception handling request flag of the third task is set ON. Then, at the time t6, the second exception handling thread is suspended in the waiting state for the third task to exit. When the second task is suspended, the task to run next is the third task.

The changer thread detects at the time t6 that the exception handling request of the third task is ON (step S806), and selects the third exception handling thread as the next running thread (step S808). The changer thread resumes the third exception handling thread (step S810), and then enters the waiting state for the first event (step S802).

When resumed at the time t6, the third exception handling thread sets its own exception handling state flag ON (step S902), and sets its own exception handling request flag OFF (step S903). The third exception handling thread then calls its own exception handler (step S904). In this exception handler, the third exception handling thread carries out processing such as deallocation of the memory area, and then calls the system function for suspending its own task. Thus, the second task suspended in the waiting state for the third task to exit enters the runnable state. Then, the third exception handling thread suspends itself in this system function (step S305). At the time t7, the task to run next is the second task.

The changer thread detects at the time t7 that the exception handling state flag of the second task is still ON (step S805), and selects the second exception handling thread again as the next running thread (step S808). The changer thread resumes the second exception handling thread (step S810), and then enters the waiting state for the first event (step S802).

When resumed at the time t7, the second exception handling thread calls, in the exception handler, the system function for making its own task exit. Thus, the first task suspended in the waiting state for the second task to exit enters the runnable state. Then, the second exception handling thread suspends itself in this system function (step S305). At the time t8, the task to run next is the first task.

The changer thread detects at the time t8 that the exception handling state flag and the exception handling request flag of the first task are both OFF (steps S805, S806), and selects the first task processing thread as the next running thread (step S807) The changer thread resumes the first task processing thread (step S810), and then enters the waiting state for the first event (steps S802). Then, the first task processing thread is again suspended in the waiting state for an input from the user.

As stated above, in the real-time OS simulator according to the present embodiment, one task processing thread and one exception handling thread are assigned to each task in the real system. The changer thread selects one of these two threads to run next. The task processing thread requests, by using the system function, another task to carry out task exception handling. The exception handling thread calls the exception handler for the requested task. Thus, the real-time OS simulator according to the present embodiment can simulate the task exception handling of the real-time OS.

In the present embodiment, two threads are previously created for each task. Alternatively, two threads may be created only for a task that executes task exception handling. Still alternatively, the exception handling thread may be dynamically created when task exception handling actually runs. As such, by reducing the number of threads concurrently running on the general-purpose OS, the real-time OS simulator can operate more rapidly.

In the real-time OS simulators according to the first through third embodiments, the real-time OS and the general-purpose OS are not limited to specific OSes. Also, the real-time OS simulator may realize synchronization between threads by using capabilities except the event capability provided by the general-purpose OS. Still further, the task processing thread and the interrupt thread may be both created by the real-time OS simulator or by any other component outside of the real-time OS simulator.

While the invention has been described in detail, the foregoing description is in all aspects illustrative and not restrictive. It is understood that numerous other modifications and variations can be devised without departing from the scope of the invention.

What is claimed is:

1. A real-time OS simulator that assigns a task processing thread to run on a general-purpose multi-thread OS to each of a plurality of tasks to run on a real-time OS and simulates an operation of said real-time OS on said multi-thread OS, said simulator comprising:
task switching instruction means for receiving a request issued from said task processing thread under same conditions as in said real-time OS, and providing an instruction for switching the tasks in response to said request; and
a task switching thread for making selected one of said task processing threads run by suspending and resuming said task processing threads with capabilities of said multi-thread OS in cooperation with said task switching instruction means.

2. The real-time OS simulator according to claim 1, wherein said task switching instruction means selects a task processing thread to run next, provides the instruction for switching the tasks to said task switching thread, and then suspends the task processing thread that has issued said request, and
in response to the instruction, said task switching thread resumes the selected task processing thread after a preceding running task processing thread is suspended.

3. The real-time OS simulator according to claim 2, wherein
in response to the instruction for switching the tasks, said task switching thread checks at predetermined intervals whether the preceding running task thread is suspended or not.

4. The real-time OS simulator according to claim 1, wherein
said task switching instruction means selects a task processing thread to run next, provides the instruction for switching the tasks to said task switching thread, and then sets the task processing thread that has issued said request in a waiting state, and
in response to the instruction, said task switching thread suspends a preceding running task processing thread, and then releases the selected task processing thread from the waiting state for resuming.

5. The real-time OS simulator according to claim 2 or 4, wherein
said task switching instruction means provides the instruction to said task switching thread after said task switching thread is enabled to start processing.

6. The real-time OS simulator according to claim 1, wherein
said task switching instruction means provides the instruction to said task switching thread after selecting a task processing thread to run next, and
said task switching thread runs with a higher priority than said task processing threads and, in response to the instruction, suspends a preceding running task processing thread and then resumes the selected task processing thread.

7. The real-time OS simulator according to claim 1, further comprising
task processing thread creating means for creating said task processing thread.

8. The real-time OS simulator according to claim 1, wherein
an exception handling thread corresponding to task exception handling of each of said tasks and running on said multi-thread OS is further assigned to each of said tasks, and
said task switching thread selects a thread to run next from among said task processing threads and said exception handling threads.

9. The real-time OS simulator according to claim 8, further comprising
thread creating means for creating said task processing thread and said exception handling thread.

10. The real-time OS simulator according to claim 1, further comprising
interrupt handling means for receiving an interrupt request issued by an interrupt thread that generates a pseudo-interrupt, suspending a running task processing thread, calling an interrupt handler corresponding to the interrupt request, and then selecting a task processing thread to run next for resuming.

11. The real-time OS simulator according to claim 10, wherein
when receiving the interrupt request from said interrupt thread while another interrupt thread is running, said interrupt handling means suspends the running interrupt thread, calls the interrupt handler corresponding to the interrupt request, and then resumes the suspended interrupt thread.

12. The real-time OS simulator according to claim 10, wherein
said interrupt thread includes a system clock interrupt thread that generates a pseudo-interrupt at predetermined time intervals.

13. The real-time OS simulator according to claim 10, further comprising
interrupt thread creating means for creating said interrupt thread.

14. A computer-readable recording medium recording a program to run on a computer, the program for a simulation method of assigning a task processing thread to run on a general-purpose multi-thread OS to each of a plurality of tasks to run on a real-time OS and simulating an operation of said real-time OS on said multi-thread OS, said simulation method comprising the steps of:
receiving a request issued from said task processing thread under same conditions as said real-time OS and providing an instruction for switching the tasks in response to said request; and
making selected one of said task processing threads run by suspending and resuming said task processing threads with capabilities of said multi-thread OS.

15. The recording medium according to claim 14, wherein
in said instruction providing step, a task processing thread to run next is selected, and then the task processing thread that has issued said request is suspended, and
in said run step, the selected task processing thread is resumed after a preceding running thread is suspended.

16. The recording medium according to claim 14, wherein
in said instruction providing step, a task processing thread to run next is selected, and then the task processing thread that has issued said request is set to a waiting state, and
in said run step, after a preceding running task processing thread is suspended, a waiting state of the selected task processing thread is cleared for resuming.

17. The recording medium according to claim 14, wherein
in said instruction providing step, a task processing thread to run next is selected, and
said run step is given a higher priority than said task processing threads, and, in said run step, after a preceding running task processing thread is suspended, the selected task processing thread is resumed.

18. The recording medium according to claim 14, wherein
an exception handling thread corresponding to task exception handling of each of said tasks and running on said multi-thread OS is further assigned to each of said tasks, and
in said run step, a thread to run next is selected from among said task processing threads and said exception handling thread.

19. The recording medium according to claim 14, wherein
said simulation method further comprises the step of receiving an interrupt request issued from an interrupt thread that generates a pseudo-interrupt, suspending a running task processing thread, calling an interrupt handler corresponding to the interrupt request, and then selecting a task processing thread to run next for resuming.

20. A program for a simulation method of assigning a task processing thread to run on a general-purpose multi-thread OS to each of a plurality of task to run on a real-time OS and simulating an operation of said real-time OS on said multi-thread OS, said simulation method comprising the steps of:
receiving a request issued from said task processing thread under same conditions as said real-time OS and providing an instruction for switching the tasks in response to said request; and
making selected one of said task processing threads run by suspending and resuming said task processing threads with capabilities of said multi-thread OS.

21. The program according to claim 20, wherein
in said instruction providing step, a task processing thread to run next is selected, and then the task processing thread that has issued said request is suspended, and
in said run step, the selected task processing thread is resumed after a preceding running thread is suspended.

22. The program according to claim 20, wherein
in said instruction providing step, a task processing thread to run next is selected, and then the task processing thread that has issued said request is set to a waiting state, and
in said run step, after a preceding running task processing thread is suspended, a waiting state of the selected task processing thread is cleared for resuming.

23. The program according to claim 20, wherein
in said instruction providing step, a task processing thread to run next is selected, and
said run step is given a higher priority than said task processing threads, and, in said run step, after a preceding running task processing thread is suspended, the selected task processing thread is resumed.

24. The program according to claim 20, wherein
an exception handling thread corresponding to task exception handling of each of said tasks and running on said multi-thread OS is further assigned to each of said tasks, and
in said run step, a thread to run next is selected from among said task processing threads and said exception handling thread.

25. The program according to claim 20, wherein
said simulation method further comprises the step of receiving an interrupt request issued from an interrupt thread that generates a pseudo-interrupt, suspending a running task processing thread, calling an interrupt handler corresponding to the interrupt request, and then selecting a task processing thread to run next for resuming.
